(19) United States
(12) Patent Application Publication
(10) Pub. No.: US 2001/0050880 A1
(43) Pub. Date: Dec. 13, 2001

(54) ROTOR FOR MACHINES MIXING ELASTOMERS AND THE LIKE WITH AN ANGLE OF ENTRY INTO THE MIXTURE WHICH IS VARIED ALONG THE EXTENSION OF AT LEAST ONE OF ITS FLANGES

(76) Inventor: ROBERTO REGALIA, LONATE POZZOLO (VARESE) (IT)

Correspondence Address: THOMAS F PETERSON, C/O LADAS & PARRY, 224 SOUTH MICHIGAN AVENUE, CHICAGO, IL, 60604

(21) Appl. No.: 09/450,064

(22) Filed: Nov. 29, 1999

(30) Foreign Application Priority Data
Nov. 30, 1998 (IT) MI98A2589

(51) Int. Cl. B01F 7/08

(52) U.S. Cl. 366/84; 366/88

(57) ABSTRACT

Rotor (5) for machines (1) mixing elastomers and the like, comprising a first section of greater axial length (L1), defining a thrusting flange (6), and a second section of smaller axial length (L2), defining a counter-thrusting flange (7), in which at least one of said thrusting flange (6) or counter-thrusting flange (7) has an angle of entry (β,σ) into the mixture, which is varied along its extension.

### DESCRIPTION

The present invention relates to a rotor for machines mixing elastomers and the like, comprising a first section of greater axial length, defining a thrusting flange, and a second section of smaller axial length, defining a counter-thrusting flange, in which at least one of said thrusting or counter-thrusting flanges has an angle of entry into the mixture which is varied along the extension of the flange itself.

It is known that in the art of processing rubber and plastics, mixing machines of the type called “internal. mixers” are used in order to obtain a mixture suitable for being transformed into the finished or semi-finished product, said mixing machines being formed internally with a mixing chamber (divided into two half-chambers) having, rotating inside them, two parallel-axis rotors which may, for example, be of the tangential or interpenetrating type.

Said rotors have essentially the function of performing:

incorporation of the various ingredients forming the processed material which below, for the sake of simplicity, will be called mixture;

dispersion, i.e. reduction in the diameter, of the fillers, such as carbon black and silica, introduced into the mixture;

distribution/homogenisation of the fillers inside the mixture so as to make the latter as uniform as possible throughout its mass.

It is also known that, while the dispersion depends on the characteristics of the flow field, such as the shearing force and deformation gradient which the rotors are able to produce on the mixture during rotation, the distribution of the fillers in the polymer matrix depends on the efficiency of the velocity field inside the mixing chamber, namely the capacity of the rotors to move the mixture without creating stagnation points and at the same time cause the mixture to flow from one half-chamber to the other. The different configurations and geometrical forms of the rotors therefore produce two different types of mixing action defined as follows:

dispersive mixing=incorporation of the particles of filler into the elastomer matrix and reduction in the mean particle diameter of the individual components incorporated; and

distributive mixing=uniform distribution and homogenisation of the particles inside the mixture.

More particularly it is known that, in order to obtain distributive mixing, it is necessary for the mixture to be subjected to two different thrusts, i.e. an axial thrust, which causes the flow of the particles of the mixture in the axial direction inside the said half-chamber, and, a transverse thrust, which causes the mixture to pass from one half-chamber to the other one. It is also known that it is to difficult to maximise the two different mixing actions at the same time since the configurations and geometrical forms of the mixing rotors (housed inside the respective half-chambers of the mixing machines), which determine an improvement in the dispersive mixing, tend to worsen the characteristics of distributive mixing and vice versa. Numerous attempts have been made, therefore, to design configurations of the rotors which would produce not just an acceptable balance between the two different mixing actions, but also simultaneous optimisation thereof.

Examples of such known rotors are for example illustrated in the patent GB-2,024,635, in which the rotor is divided into two axial sections of different length forming respectively the thrusting vane (of greater length) and the counter-thrusting vane (of smaller length).

Said rotor has constant helix angles and, although functional, it consequently operates in an identical manner in all the zones of the flow field inside the mixing chamber, not allowing simultaneous maximisation of the two dispersive and distributive mixing actions throughout the flow field of the chamber.

The technical problem which is posed, therefore, is that of providing a rotor for machines mixing elastomer products, which has geometrical characteristics relating to the three-dimensional form and cross-section which are such as to allow simultaneous maximisation of the dispersive and distributive mixing actions in every point of the flow field.

Within the scope of this problem a further requirement is the need to produce an optimum phase-displacement angle between two identical rotors mounted parallel with each other inside a mixing machine.

These technical problems are solved according to the present invention by a rotor for machines mixing elastomers and the like, comprising at least one first section of greater axial length, defining a thrusting flange, and at least one second section of smaller axial length, defining a counter-thrusting flange, in which at least one of said flanges has an angle of entry into the mixture which is varied along its extension.

Further details may be obtained from the following description of a non-limiting example of embodiment provided with reference to the accompanying drawings in which:

FIG. 1 shows a schematic sectional view of an internal mixer of the conventional type;

FIG. 2 shows a perspective view of a rotor according to the present invention;

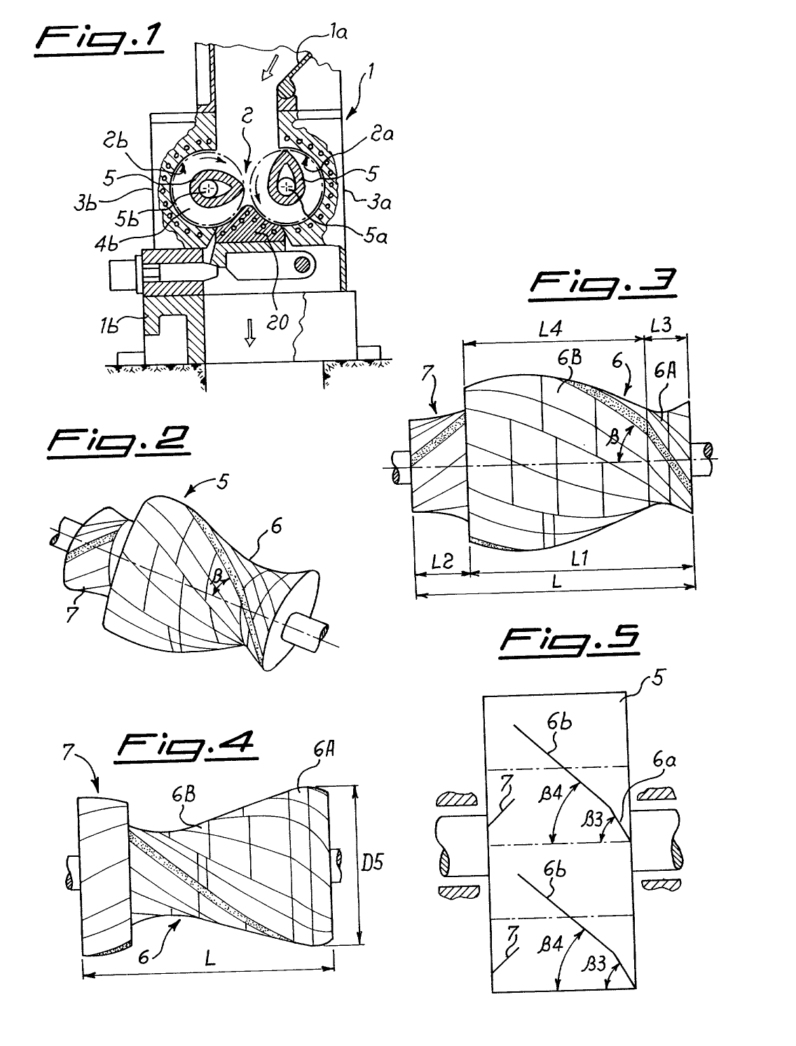

FIG. 3 shows a side view of the rotor according to FIG. 2;

FIG. 4 shows a side view of the rotor according to FIG. 2 rotated through 90°;

FIG. 5 shows the planar development of the profile of the rotor according to the present invention;

FIG. 6 shows a cross-sectional view of the mixing chamber with an enlarged detail of the external edge of the rotor according to the invention;

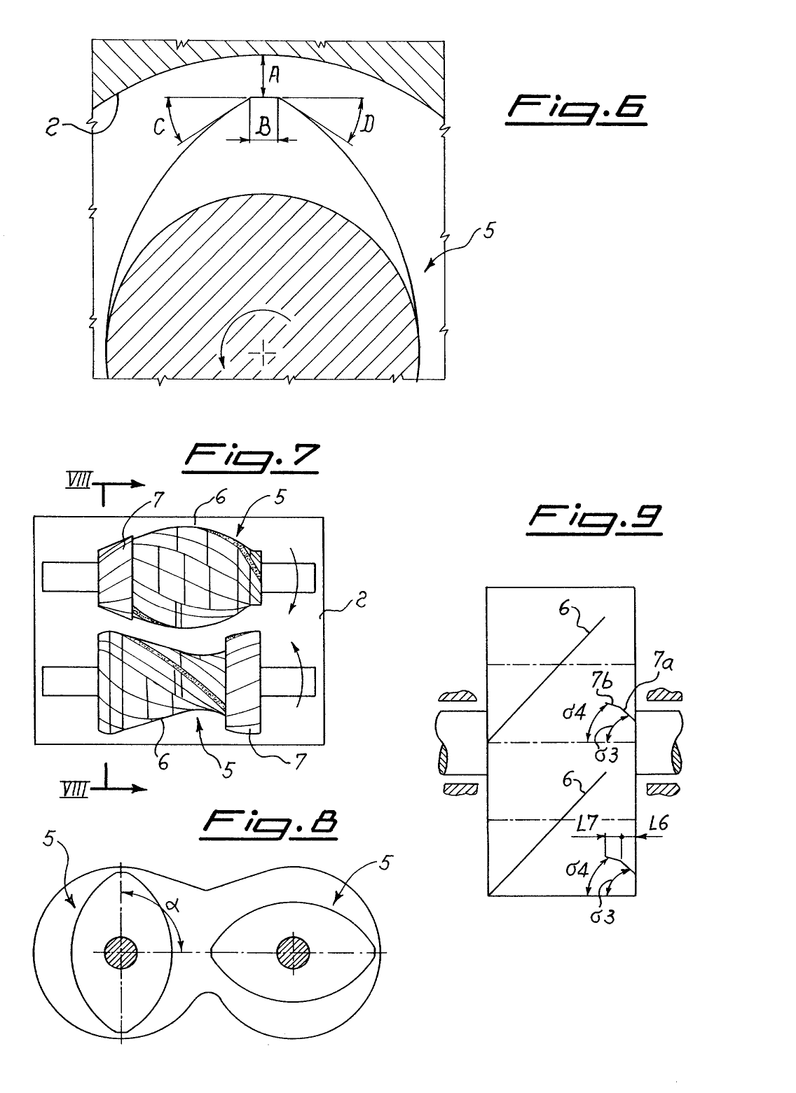

FIG. 7 shows a top plan view of the mixing chamber of a machine equipped with two rotors according to the invention;

FIG. 8 shows a sectional view along the plane indicated by VIII-VIII in FIG. 7; and

FIG. 9 shows the planar development of a further profile of the rotor according to the present invention.

As illustrated, an internal mixer 1 comprises a top loading part 1a, a mixing chamber 2 and a base 1b with a hatch 20 for opening the mixing chamber in order to unload the mixture at the end of the cycle.

The chamber 2 is in turn formed by two walls 3a,3b and two shoulders (only 4b is visible in FIG. 1) which define the typical configuration of intersecting circumferences of the chamber, which is thus divided into two half-chambers 2a,2b housing internally the respective rotors 5 which in the example are of the tangential type and which rotate about a respective longitudinal axis 5a,5b.

The rotors 5 have a substantially cylindrical shape with an overall length L and diameter D5, but are divided in the longitudinal direction into two separate sections, one of which L1 of greater length, forming the mixture thrusting vane 6, and one L2 of smaller length, which forms the mixture counter-thrusting vane 7.

The two rotors 5 are moreover mounted opposite each inside the chamber 2 (FIGS. 1,7) so that each thrusting vane 6 has, corresponding to it, the counter-thrusting vane 7 of the other rotor so as to produce a pressure gradient between the two rotors which facilitates passage of the mixture from one half-chamber to the other, allowing closing of the travel path of the mixture particles which thus circulate inside the chamber passing from one half-chamber to the other, causing the desired distributive mixing.

As shown in FIGS. 2 and 3, the rotors 5 have a thrusting vane 6 with an angle P of entry into the mixture (i.e. the angle between the axis of rotation of the rotor and a line tangential to any point on the crest of the helix) variable along the extension of the helix of the vane itself.

This variation may be of the continuous type or discontinuous type.

More particularly (FIGS. 3 and 5), the thrusting vane 6 has:

a first section 6a with an axial length L3, forming an angle β3 of between 15° and 75°; preferably this angle β3 is between 15° and 60°; and

a second section 6b with an axial length L4, forming an angle β4 of between 15° and 75°; preferably this angle β4 is between 25° and 60°.

It has also been demonstrated that the ratio between the lengths in the longitudinal direction L1 and L2 of the two rotor thrusting and counter-thrusting sections may be advantageously between 0.05 and 0.5.

In addition to the variation in the angle of entry of the thrusting flange, it has been experimentally demonstrated that improvements in the dispersive mixing action are obtained by providing a rotor cross-section having the following characteristics illustrated in FIG. 6 where the parameters A,B,C,D have the following meaning:

A=the minimum distance between the crest of the rotor and the internal wall of the associated mixing half-chamber;

B=the width of the rotor crest;

C=angle of mastication of the mixture;

D=angle of exit from the mixture.

In particular the geometry of the cross-section is preferably characterized by values of A such that:

the ratio between the minimum distance of the crest of the rotor with a diameter D5 and the chamber wall lies within the following values:

0.01<A/D5<0.015

the ratio between the minimum distance (A) of the rotor crest from the chamber wall and the width (B) of the crest itself lies within the following values:

0.10<A/B<0.5 and preferably 0.15<A/B<0.25

the angle (C) of mastication of the mixture is between 15° and 35° and preferably between 20° and 25°;

the angle (D) of exit from the mixture is between 25° and 70° and preferably between 35° and 60°.

The parameter D therefore tends to be increased since the greater its value the greater the space which is produced between the counter-thrusting flange and the thrusting flange of the two rotors, which increases the pressure gradient in the zone where the mixture passes from one half-chamber to the other, favouring overall an improvement in distributive mixing.

FIG. 9 shows the planar development of a further profile of the rotor according to the present invention: in this case it is the counter-thrusting flange 7 which has an angle of entry a into the mixture which is varied along the extension of the helix. More particularly the counter-thrusting flange has:

a first section 7a with an axial length L6, forming an angle σ3 of between 15° and 75°; preferably this angle σ3 is between 30° and 60°; and

a second section 7b with an axial length L7, forming an angle σ4 of between 15° and 75°; preferably this angle σ4 is between 25° and 60°.

Although described by way of example in two versions with a single variation of the angle for the thrusting flange or for the counter-thrusting flange, it is obvious that a person skilled in the art may choose to provide different combinations of variations of the two flanges, i.e. thrusting flange and counter-thrusting flange, and may also introduce more than one variation in angle for the same flange both separately and in combination with one or more variations in angle of the other flange.

Once the two rotors have been assembled inside the mixing chamber 2 of the machine 1, it is also necessary to ensure that they are angular phase-displaced by a certain angle so as to achieve optimisation of that part of the distributive mixing action due to the exchange of material between the two half-chambers 2a,2b; more particularly (FIGS. 8,9) the angle a of angular phase-displacement between the two rotors is advantageously between 70° and 125° and preferably between 85° and 120°.

1. Rotor (5) for machines (1) mixing elastomers and the like, comprising at least one first section of greater axial length (L1), defining a thrusting flange (6), and at least one second section of smaller axial length (L2), defining a counter-thrusting flange (7), characterized in that at least one of said thrusting flange (6) or counter-thrusting flange (7) has an angle of entry (β,σ) into the mixture, which is varied along its extension.

2. Rotor according to claim 1, characterized in that said angle of entry (β,σ) into the mixture varies in a continuous manner.

3. Rotor according to claim 1, characterized in that said angle of entry (β,σ) varies in a discontinuous manner.

4. Rotor according to claim 1, characterized in that said thrusting flange (6) or said counter-thrusting flange (7) has a first section (6a,7a) with an angle of entry (β3,σ3) of between 15° and 75°.

5. Rotor according to claim 4, characterized in that said angle of entry (β3,σ3) of the first section (6a, 7a) of the thrusting flange (6) or of the counter-thrusting flange (7) is preferably between 30° and 60°.

6. Rotor according to claim 1, characterized in that said thrusting vane (6) or said counter-thrusting vane (7) has a second section (6b,7b) with an angle of entry (β4,σ4) of between 15° and 75°.

7. Rotor according to claim 6, characterized in that said angle of entry (β4,σ4) of the second section (6b,7b) of the thrusting flange (6) or of the counter-thrusting flange (7) is preferably between 25° and 60°.

8. Rotor according to claim 1, characterized in that both the thrusting flange (6) and the counter-thrusting flange (7) has an angle of entry into the mixture, which is varied along its extension.

9. Rotor according to claim 1, characterized in that the ratio between the axial lengths (L1,L2) of the thrusting flange (6) and the counter-thrusting flange (7) is between 0.05 and 0.5.

10. Rotor according to claim 1, characterized in that the ratio (A/D5) between the minimum distance (A) of the crest of the rotor (5) and the wall of the chamber (2) and the diameter (D5) of the rotor itself lies within the following values:
0.01<A/D5<0.015

11. Rotor according to claim 1, characterized in that the ratio between the minimum distance (A) of the crest of the rotor (5) and the width (B) of the crest itself lies within the following values:
0.10<A/B<0.5

12. Rotor according to claim 11, characterized in that the ratio between the minimum distance (A) of the crest of the rotor (5) and the width (B) of the crest itself lies preferably within the following values:
0.15<A/B<0.25

13. Rotor according to claim 1, characterized in that the angle (C) of mastication is between 15° and 35°.

14. Rotor according to claim 13, characterized in that the angle (C) of mastication of the mixture is preferably between 20° and 25°.

15. Rotor according to claim 1, characterized in that the angle (D) of exit from the mixture is between 25° and 70°.

16. Rotor according to claim 1, characterized in that the angle (D) of exit from the mixture is preferably between 35° and 60°.

17. Machine for mixing elastomers and the like, comprising a mixing chamber (2) divided into two half-chambers (2a,2b), each of which houses internally a rotor (5) which has a first section (L1) of greater length in the axial direction, defining a thrusting flange (6), and a second section (L2) of smaller length in the axial direction, defining a counter-thrusting flange (7), characterized in that said thrusting flange has an angle (β) of entry into the mixture, variable along the extension of the thrusting flange itself.

18. Machine according to claim 17, characterized in that the angle (α) of angular phase-displacement between the two rotors (5) is between 70° and 125°.

19. Rotor according to claim 18, characterized in that said angle (α) of phase-displacement is preferably between 85° and 120°.
